(19) United States
(12) Patent Application Publication
(10) Pub. No.: US 2014/0168659 A1
(43) Pub. Date: Jun. 19, 2014

(54) MICROMACHINED METAL DIAPHRAGM BASED FABRY-PEROT FIBEROPTIC SENSOR SYSTEM AND DATA PROCESSING INVOLVING THE SAME

(71) Applicants: Vinod Kumar Suri, Mumbai (IN); Shivam Mishra, Mumbai (IN); R. Balasubramaniam, Mumbai (IN); Shrinkhla Ghildiyal, Mumbai (IN)

(72) Inventors: Vinod Kumar Suri, Mumbai (IN); Shivam Mishra, Mumbai (IN); R. Balasubramaniam, Mumbai (IN); Shrinkhla Ghildiyal, Mumbai (IN)

(73) Assignee: THE SECRETARY, DEPARTMENT OF ATOMIC ENERGY, GOVT. OF INDIA, Mumbai (IN)

(21) Appl. No.: 13/977,263

(22) PCT Filed: Dec. 28, 2010
(86) PCT No.: PCT/IN10/00861

§ 371 Date: Jan. 20, 2014

(51) Int. Cl. G01L 9/00

(52) U.S. Cl. CPC G01L 9/0079
USPC 356/480

(57) ABSTRACT

The present invention relates to micro machined metal diaphragm for Fabry-Perot interferometer sensor and Fabry Perot Fiber optic Sensor system using said metal diaphragm and method of fabrication thereof. Fabry Perot sensor with micro machined metallic diaphragms at the fiber optic end is developed ensuring accuracy, controllability by deterministic process. Advantageously, the system involves the metal diaphragm with high reflectivity inside surface facing the fiber end as a basic functional element. Importantly, the micro machined metal diaphragm is miniaturized to suit various critical applications including bio medical sensing devices for measuring various physiological parameters with desired accuracy. The metallic diaphragm based Fabry-Perot fiber optic sensor is directed to favour wide scale applications such as for measuring various parameters in nuclear industry, Chemical and Electrically harsh industry, biomedical applications with desired precision and favorable performance largely unaffected by radiation, high temperature or highly corrosive environment at work/application.

### FIELD OF THE INVENTION

The present invention relates to micro machined metal diaphragm for Fabry Perot interferometer sensor and Fabry Perot Fiberoptic Sensor system using said metal diaphragm and a method of fabrication thereof. More particularly, the present invention relates to developing Fabry Perot sensor with micro machined metallic diaphragms at the fiber optic end with accuracy, controllability by deterministic process. Advantageously, in the system of the invention involves as a basic functional element the metal diaphragm with high reflectivity inside surface facing the fiber end. Importantly, the micro machined metal diaphragm is miniaturized to suit various critical applications including bio medical sensing devices for measuring various physiological parameters with desired accuracy. The metallic diaphragm based Fabry-Perot fiber optic sensor according to the present invention is directed to favour wide scale applications such as for measuring various parameters in nuclear industry, Chemical and Electrically harsh industry, biomedical applications and the like with desired precision and favorable performance suitable for radiation, high temperature or corrosive environment at work/application.

### BACKGROUND ART

It is known in the related art that Fabry Perot Interferometer (FPI) based fiber optic sensors for measuring instruments for a number of variable physical parameters like pressure, temperature, strain etc. Pressure sensors based on FP principle have been reported with Silicon diaphragm or diaphragm made of dielectric layer(s) on silicon structure using surface/bulk micromachining processes. FP transducers with chemically etched cavity at fiber end and glass/silica diaphragm joined by anodic bonding to fiber have also been reported in the art. Two fiber ends (with/without metal deposition to enhance the reflectivity) facing each other and secured inside a capillary are also known to be used as FP sensor for strain or temperature measurement.

The conventional Semi-Conductor material i.e. Silicon which is prevalent in sensor industry suffer from the limitation of being brittle in radiation environment. Si is prevalent in sensor industry mostly because of miniaturization and most of these sensors are electrical sensor. Radiation produces the lattice damage in Si by displacing the atoms from their original positions and thereby generating Si interstitials and corresponding vacancies. As a result, new states are created in the semiconductor forbidden band gap. Some of these defects have −ve impact on the electrical performance of Si viz shorter carrier life time, increased leakage current and full depletion voltage of Si substrate changes due to acceptor like radiation induced defects.

The metal to Si bonding is problematic. Due to the large temperature coefficient mismatch; it may cause large thermal and residual stress as well as distortion in the diaphragm, which may further lead to the malfunctioning of device; it may also overshadow the measurand effect; hence packaging of such sensors (for harsh industrial application) is difficult and thus could not be commercially applied and used.

Silica/glass based sensors are reported at few places but only at laboratory scale and their suitability for industrial applications could not be established.

U.S. Pat. No. 6,281,976 disclosed a single mode fiber containing intrinsic FP interferometer which is bonded at one end to the stainless steel diaphragm. Intrinsic consists of two partially reflecting mirrors, with each partial mirror made by thermal fusion of a mirrored fiber end against another fiber end. A metallic diaphragm is attached to one of them. External parameter e.g. pressure causes longitudinal tension/compression in fiber and thereby changes the cavity length. Metal diaphragm in this case does not act as a mirror of the FP cavity; it is bonded to the end of the optical fiber having intrinsic FP sensor and assists only in straining the optical fiber. Therefore, full range deflection of the diaphragm is limited by maximum allowed strain in the fiber and hence such a sensor has low sensitivity & resolution.

U.S. Pat. No. 6,823,738 is related to fiber optic pressure sensor with metallic diaphragm assembled on the end of optical fiber or optical fiber bundle of two or more fibers wherein reflected light intensity changes with the deflection of metallic diaphragm, under applied pressure. Here either same input fiber or different fibers can carry the reflected signal. Such systems have the disadvantages like nonlinearity, low sensitivity and need frequent calibration. However, this pressure sensor is not adapted for FP interferometer based sensing.

U.S. Pat. No. 6,820,488 disclosed a fiber optic pressure sensor with metallic head attached to an end of fiber. Reflected light intensity changes with the deflection of metallic diaphragm under applied pressure. Inside surface of diaphragm has pattern of high and low areas of reflectivity. This sensor is based on intensity measurement and does not fall under FP interferometric type sensors.

There has been therefore a need in the related art for developing a simple yet robust construction of the FP interferometer based miniature sensor head involving micro machined reflective metallic diaphragm which would be simple, durable and cost effective as well as versatile in application to meet the requirement of radiation, corrosion or high temperature operating condition in a safe, accurate and reliable manner. The present invention attempts to provide for the first time desired micro machined metal diaphragm based miniature sensor head for specific difficult to operate FP interferometer based application (i.e. high temperature and/or high radiation and/or corrosive environment and/or Electromagnetic Interference) for very low to very high value of the measurand with high sensitivity and accuracy. While miniaturization of reflective metallic diaphragm based sensor is one of the basic aspects of the present invention, a wide range of size as well as measurand parameters are also targeted by way of the technical advance under the invention. The invention also directs to advancements in packaging of such novel micro sensor/probe head for possible favorable industrial application. The instrumentation systems using such FP interferometer involving micromachined reflective metal diaphragm on one hand would ensure precision and accuracy of measurement of various parameters and on the other hand provide miniature as well as customized sensing head configuration capable of application in industrial processes as well as bio medical application.

### OBJECTS OF THE INVENTION

It is thus the basic object of the present invention to provide a micro/miniature sensor head involving micro machined reflective metallic diaphragm and micro machined FP cavity and Fabry Perot Interferometer based fiber optic sensor using such reflective metal diaphragm adapted to measure physical parameters like pressure, temperature, strain and the like with desired precision and reliability free of damage/error due to radiation, Electromagnetic Interference (EMI) or corrosive environment and method of its fabrication.

Another object of the present invention is directed to fabrication of a micromachined reflective metallic diaphragm based Fabry-Perot fiber optic sensor system with accuracy and controllability through a deterministic process and measurement of parameters.

Yet another object of the present invention is directed to a micromachined reflective metallic diaphragm based Fabry-Perot fiber optic sensor wherein the base metal of said diaphragm is selected from engineering metals and metal alloys such as any of Brass, Stainless Steel, Copper/Copper Alloy, and Nickel or Titanium Alloys depending on specific application.

A′further object of the present invention is directed to a micromachined reflective metallic diaphragm based Fabry-Perot fiber optic sensor system wherein material/metal for the components of sensing head is selectively used so that the sensor is suitable for application in high temperature or radiation environment.

A still further object of the present invention is directed to micromachined reflective metallic diaphragm based Fabry-Perot fiber optic sensor wherein said ultra precision diaphragm is machined involving conventional machining comprising Diamond turn machining and/or non-conventional machining photo chemical machining, micro-EDM, micro-Wire EDM, micro-milling, micro turning, hybrid polishing techniques etc for achieving desired dimensional accuracy, precision and surface quality.

A further object of the present invention is directed to a micromachined reflective metallic diaphragm based Fabry-Perot fiber optic sensor system wherein miniature sensors are provided for applications where size and weight are critical factor including bio medical applications.

A still further object of the present invention is directed to developing a micromachined reflective metallic diaphragm based Fabry-Perot fiber optic sensor system wherein sensing head can be fabricated using selective metal alloys compatible with highly corrosive environment.

A still further object of the present invention is directed to developing a micromachined reflective metallic diaphragm based Fabry-Perot fiber optic sensor system wherein sensing head does not contain any electronic components and hence is compatible for extreme condition of EMI.

A still further object of the present invention is directed to developing a micromachined reflective metallic diaphragm based Fabry-Perot fiber optic sensor system wherein the FP cavity is produced on metallic sensor head using micro machining and/or photo chemical machining (PCM) process to ensure desired accuracy and precision of dimension/length of cavity.

A still further object of the present invention is directed to developing a micromachined reflective metallic diaphragm based Fabry-Perot fiber optic sensor system wherein a nano finished metallic diaphragm fabricated by ultra precision micro machining providing high reflectivity of more than 85% is used as one of the mirror of Fabry-Perot interferometer ensuring higher power in reflected signal from FPI sensor which can be further adapted for yet further enhanced reflectivity by selective coating and the like.

A still further object of the present invention is directed to developing a micromachined reflective metallic diaphragm based Fabry-Perot fiber optic sensor system wherein the metallic diaphragm act as a sensing element for measuring a parameter value e.g. pressure from the analysis of reflected spectrum corresponding to a given FP cavity length.

A still further object of the present invention is directed to developing a micromachined reflective metallic diaphragm based Fabry-Perot fiber optic sensor system wherein an end face of optical fiber acts as another partially reflecting mirror of FP interferometer which can be further enhanced by suitable selective coating and the like.

A still further object of the present invention is directed to developing a micromachined reflective metallic diaphragm based Fabry-Perot fiber optic sensor system wherein the detection of cavity length is based on white light interferometry and a broad band optical source, preferably Tungsten-Halogen lamp or a super luminescent LED or any other suitable light source including laser source used for injecting light through a single mode or multimode optical fiber into the Fabry-Perot cavity.

A still further object of the present invention is directed to developing a micromachined reflective metallic diaphragm based Fabry-Perot fiber optic sensor system wherein the metallic diaphragm acts as a pressure sensing element which deflects when subjected to external pressure which in turn changes the FP cavity length and resultantly changes the output optical signal indicative of the parameter value being measured.

### SUMMARY OF THE INVENTION

The basic aspect of the present invention is directed to a micro machined FP Sensor_head comprising nano-finished flexible reflective metal diaphragm having diaphragm thickness in the range of 0.025 mm to few mm preferably 0.025 mm to few hundred micrometers and diaphragm diameter in the range of 1 mm to 50 mm preferably 1 mm to 25 mm.

Another aspect of the present invention is directed to micro machined FP Sensor_head wherein the metal diaphragm comprises engineering metal and alloys such as any of Brass, Stainless Steel, Copper/Copper Alloy, and Nickel or Titanium Alloys depending on specific application.

A still further aspect of the present invention is directed to a micro machined FP Sensor head comprising a flanged diaphragm structure with high reflectivity inside surface adapted to face an optical fiber, said flexible metallic diaphragm adapted such that when the same is subjected to external parameters the same deflects for desired sensing purposes.

According to yet another aspect of the present invention is directed to a micro machined
FP Sensor head comprising a flexible metal diaphragm comprising a diaphragm structure with high reflectivity inside surface adapted to face an optical fiber, said flexible metallic diaphragm adapted such that when the same is subjected to external parameters the same deflects for desired sensing purposes.

Also said micro machined FP Sensor head is comprising reflective coatings on inside surface including preferably coatings selected from gold, silver, aluminum and the like.

A still further aspect of the present invention is directed to a process for the manufacture of a micro machined FP Sensor head comprising the steps of:
i) providing a metal blank with suitable thickness, lapping its backside surface such that the blank can be held at vacuum chuck and obtaining the desired outside diameter;
ii) subjecting the metal blank obtained in (i) to ultra precision micro machining involving single crystal diamond tools such as to obtain suitable diaphragm thickness and a nano finished mirror like flexible reflective diaphragm.

According to yet another aspect of the present invention is directed to a process for the manufacture of a micro machined FP sensor head wherein said step of micro-machining of the metal diaphragm comprises deterministic machining process carried out on the metal diaphragm involving a) ultra precision machining and b) ultra precision single crystal diamond tool.

A still further aspect of the present invention is directed to a process for the manufacture of a micro/miniature probe head wherein said ultra precision machining comprises Diamond Turn Machining preferably involving spindle run out within 20 nanometer, position accuracy 10 nm with aerostatic spindle and hydrostatic table mounted on granite bed and vibration isolation system with components being held on vacuum chuck to avoid distortion due to clamping forces and using said ultra precision single crystal diamond tool comprising top-rake surface as <110> plane, cutting edge sharpness ˜200 nm, and cutting edge waviness accuracy with sub-nanometer range.

Importantly in said process for the manufacture of a micro machined FP sensor head, in case of ferrous metal diaphragm subjected to the DTM machine, a cubic boron nitride cutting tool is used.

According to yet another aspect of the present invention directed to said process for the manufacture of a micro machined FP sensor head wherein the desired outside diameter of the metal diaphragm is obtained involving processes including PCM and/or EDM and thereafter the same is mounted onto suitable fixtures which in turn is mounted on the DTM machine.

A still further aspect of the present invention directed to a process for the manufacture of a micro machined FP sensor head comprising providing a flanged diaphragm structure with high reflectivity surface adapted to define an ultra precision recessed cavity surface having specular reflection when assembled facing a metallic ferrule/sleeve having an optical fiber.

Further said process for the manufacture of a micro machined FP sensor head comprising providing the diaphragm structure with high reflectivity surface having specular reflection adapted to be assembled facing a metallic ferrule/sleeve having an optical fiber and spaced from the fiber end by an intermediate spacer means.

A still further aspect of the present invention is directed to said Fabry-Perot interferometer fiber optic sensor system comprising:
FP fiberoptic sensor assembly involving an FP cavity defined by at least a metallic flexible diaphragm/sensing head comprising nano-finished flexible reflective metal diaphragm having diaphragm thickness in the range of 0.025 mm to few mm preferably 0.025 mm to few hundred micrometers and diaphragm diameter in the range of 1 mm to 50 mm preferably 1 mm to 25 mm, and a cooperatively connected metallic ferrule/sleeve at the fiber end;
measurand operatively connecting, to said assembly;
said flexible metallic diaphragm adapted such that when the same is subjected to external parameters the same deflects and changes the FP cavity length which in turn changes the spectrum of optical signal wherein the said change in spectrum is calibrated to favour measuring said external parameter.

According to yet another aspect of the present invention is directed to a Fabry-Perot interferometer fiber optic sensor system comprising:
at least a metallic flexible diaphragm and a metallic ferrule/sleeve which are assembled at the optical fiber/fiber optic cable end providing for the FP fiberoptic sensor assembly involving an FP cavity;
said metal diaphragm comprising a flanged diaphragm structure with high reflectivity inside surface facing the fiber and an ultra precision micro machined recessed cavity with depth as per desired FP cavity length and surface finish having specular reflection assembled on the said metallic ferrule/sleeve at the said optical fiber end;
measurand operatively connecting to said assembly;
said flexible metallic diaphragm adapted such that when the same is subjected to external parameters the same deflects and changes the FP cavity length which in turn changes the spectrum of optical signal wherein the said change in spectrum is calibrated to favour measuring said external parameter.

A still further aspect of the present invention directed to said Fabry-Perot interferometer fiber optic sensor system comprising:
at least a flexible metallic diaphragm/sensing head and a metallic ferrule/sleeve which are assembled at the optical fiber/fiber optic cable end providing for the FP fiberoptic sensor assembly involving an FP cavity comprises a spacer ring preferably the thickness of the spacer ring determining the FP cavity length;
said flexible metal diaphragm comprising a diaphragm structure with high reflectivity inside surface facing the fiber and having specular reflection assembled on the said metallic ferrule/sleeve at the said optical fiber end;
measurand operatively connecting to said assembly;
said flexible metallic diaphragm adapted such that when the same is subjected to external parameters the same deflects and changes the FP cavity length which in turn changes the spectrum of optical signal wherein the said change in spectrum is calibrated to favour measuring said external parameter.

Importantly, in said Fabry-Perot interferometer fiber optic sensor system of the present invention, said external parameters include pressure, temperature, vacuum, strain, flow, level, depth of fluid column, bio medical sensors, environmental parameters etc.

According to yet another aspect of the present invention directed to said Fabry-Perot interferometer fiber optic sensor system wherein said flexible metallic diaphragm surface finish is of less than 10 nm selectively obtained involving ultra precision micro-nano turning, buffing, electrochemical polishing, hybrid polishing techniques and said spacer ring is obtained involving photo chemical machining involving lithography and/or micro EDM oh metal sheet.

A still further aspect of the present invention is directed to said Fabry-Perot interferometer fiber optic sensor system wherein the detection of cavity length is based upon interferometry comprising means for injecting light through a single mode or multiple mode optical fiber into the fabry-Perot cavity, the reflected spectrum from the FP cavity having intensity modulation with number of wavelength peaks and valleys therein, diffraction grating based optical spectrum analyzer to determine the wavelength values for which peaks and for valleys occur in the reflected spectrum and determine the FP cavity length based thereon and/or involving an optical cross co-relator.

Importantly, in said Fabry-Perot interferometer fiber optic sensor system, said metallic diaphragm is adapted to act as a sensing element as well as a mirror of FP cavity.

Also in said Fabry-Perot interferometer fiber optic sensor system, said metallic ferrule is adapted such that the fiber is embedded concentrically in the said metal ferrule and its outer surface is provided with standard threading to facilitate further assembling.

According to yet another aspect of the present invention directed to said Fabry-Perot interferometer fiber optic sensor system wherein the flatness value is within 2 μm across the metal ferrule diameter and the said optical fiber is inserted and assembled such that it is in face with front face of the metallic ferrule, the said metallic diaphragm is adapted to match the size of the said metal ferrule.

Advantageously, said Fabry-Perot interferometer fiber optic sensor system further comprises coated metallic diaphragm and fiber preferably gold coated metallic diaphragm and gold coated fiber for enhanced performance.

According to yet another aspect of the present invention is directed to a Fabry Perot sensing head assembly comprising:
a metal ferrule;
a fiber embedded/positioned concentrically in said metal ferrule having its outer surface threaded for further assembling;
said optical fiber inserted and assembled such that it is in face with the front face of the metallic ferrule;
a flanged flexible metallic diaphragm with or without a spacer providing for the sensing element adapted to match and assemble with respect to said metal ferrule of said sensing head assembly involving an FP cavity adapted for facilitating the external parameter sensing/measurements.

In said Fabry Perot sensing head assembly, said FP cavity is adapted to act as a sensor for environmental parameters including pressure, strain, temperature and vacuum etc.

Preferably said Fabry Perot sensing head assembly comprises coated metallic diaphragm and fiber, preferably gold coated metallic diaphragm and gold coated fiber for enhanced performance.

According to another aspect of the present invention directed to said Fabry Perot sensing head assembly wherein the said metallic diaphragm is secured to said metal ferrule preferably by anyone or more of laser welding, ultrasonic welding and EB welding.

A still further aspect of the present invention is directed to a method for manufacturing a Fabry-Perot interferometer fiber optic sensor system comprising:
providing the said nano finished flexible metallic diaphragm/sensing head involving mechanical micro machining process and joining to said metallic ferrule/sleeve of the fiber end which are assembled at the optical fiber end providing for the FP fiberoptic sensor assembly involving an FP cavity;
said metal diaphragm obtained as a flanged or a flat diaphragm structure with high reflectivity inside surface facing the fiber and an ultra precision micro machined recessed cavity with depth as per desired FP cavity length and surface having specular reflection assembled on the said metallic ferrule/sleeve at the said optical fiber end;
providing for the measurand operatively connecting to said assembly;
providing means for noting deflections and changes in the FP cavity length based on deflection of the flexible diaphragm which in turn is adapted to change the spectrum from an optical signal source; and
providing means for identifying change in spectrum calibrated to determine the measurand.

Also said method comprising providing a spacer ring preferably with the thickness of the spacer ring determining the said FP cavity length wherein the said metallic spacer ring and circular planer diaphragm are developed involving photo chemical machining involving lithography on metal sheet and/or micro electro discharge processes.

According to another aspect of the present invention directed to said method wherein a flanged metallic diaphragm with micron size step is developed, the fiber placed on the first step with the length of FP cavity defined by distance between the step at which the fiber end is placed and mirror surface of diaphragm;

a metal sleeve is developed involving hybrid mechanical machining process, diaphragm is assembled at one end of the sleeve such that the joint is leak proof, a ferrule terminated optical fiber is inserted from the other end of the sleeve and joined to the sleeve with the sleeve adapted to maintain the fiber end and diaphragm parallel to each other and forms a Fabry Perot cavity between the diaphragm and optical fiber end.

According to an aspect of the present invention said method comprising:
providing the metal ferrule with a threaded outer surface with the flatness value within 2 μm across the metal ferrule diameter;
embedding the fiber concentrically in the metal ferrule/sleeve;
optical fiber is inserted and assembled such that it rests on the face on which FP cavity is made by ultra precision micro machining;
providing the metallic diaphragm having surface finish of less than 10 nm and of sizes matching with the metal ferrule and joining the same involving anyone or more of laser welding, ultrasonic welding and EB welding.

Preferably in said method, said FP cavity is developed with gold coated metallic diaphragm and gold coated fiber.

Another aspect of the present invention is directed to a method for measuring external parameters using the metallic diaphragm based Fabry-Perot interferometer fiberoptic sensor system wherein when the metal diaphragm which is the sensing element of the system is subjected to external parameter whereby the metal diaphragm deflects and causes the change in fabry perot cavity length, which in turn changes the reflected spectrum optical signal such that the change in signal is calibrated with the measurand.

Said method comprising the steps of

injecting light through a single mode or multimode optical fiber into the fabry perot cavity from a broad band optical source such as Tungsten-Halogen Lamp or a super luminescent LED or any other suitable optical source including laser source;

A further aspect of the present invention is directed to said method comprising the steps of

injecting light through a single mode or multimode optical fiber into the fabry perot cavity from a broad band optical source such as Tungsten-Halogen Lamp or a super luminescent LED;

generating intensity modulation of the reflected spectrum from said FP cavity with a number of wavelength peaks and valleys therein;

computing inverse values of peak wavelengths in FPI reflected optical spectrum which are in arithmetic progression and follow linearity with order number of peak;

using the slope of the best fit line for (peak wavelength)⁻¹ versus the parameter value to determine the cavity length where cavity length=|1/(2*slope)|;

obtaining the measurand value e.g. pressure, temperature, strain and vacuum which is directly proportional to said cavity length;

The present invention and its objects and advantages are described in greater details with reference to the following accompanying non limiting illustrative drawings.

### BRIEF DESCRIPTION OF THE ACCOMPANYING DRAWINGS

FIG. 1: is the schematic illustration of an arrangement of pressure measurement using micro machined metallic diaphragm based Fabry-Perot interferometer fiber optic Sensor system according to the present invention.

FIG. 1(a): is the schematic illustration of the miniature micro machined flanged metal diaphragm with micron sized step fabricated using micromachining for use in 1^{st} embodiment of fabry-perot fiber optic sensor;

FIG. 1(b): is the schematic illustration of the sleeve, for sensor head of 1^{st} embodiment of FP fiber optic sensor.

FIG. 1(c): is the schematic illustration of the Standard ferruled optical fiber for coaxial connection with the sleeve for assembly with micro machined metal diaphragm to FP fiber optic sensor of the first embodiment.

FIG. 2: is the schematic illustration showing the assembly of components as in FIG. 1(a) to (c) for the 1^{st} embodiment of FP fiber optic sensor.

FIG. 3(a): is the schematic illustration of another metal ferrule for fabrication of 2^{nd} embodiment of the FP fiber optic sensor according to the present invention.

FIG. 3(b): is the schematic illustration of yet another metal ferrule which_accommodates concentrically an optical fiber with prepared end face for fabrication of sensor head in 2^{nd} embodiment of the FP fiber optic sensor according to the present invention.

FIG. 3(c): is the schematic illustration of another metal ferrule with a recessed micro machined concentric cavity which defines the FP cavity length and accommodates concentrically an optical fiber with prepared end face for fabrication of sensor head in 2^{nd} embodiment of the FP fiber optic sensor according to the present invention.

FIG. 4: is the schematic illustration of the metal diaphragm with a recessed portion fabricated in 2^{nd} embodiment of by conventional tool based ultra precision mechanical micro machining process.

FIG. 5(a): is the schematic illustration of the circular planer metal diaphragm in 2^{nd} embodiment of fabricated with polished/buffed/nano machined metallic sheet using photo chemical machining (PCM) process.

FIG. 5(b): is the schematic illustration of the spacer ring defining the FP cavity of the sensor head, fabricated with photo chemical machining (PCM) process using lithography on metal sheet.

FIG. 6(a): is the schematic illustration of the assembled FP fiber optic sensor in 2^{nd} embodiment with metallic diaphragm of FIG. 4 fabricated by micromachining process joined on metal ferrule of type shown in FIG. 3 (a).

FIG. 6(b): is the schematic illustration of the assembled FP fiber optic sensor in 2^{nd} embodiment with metallic diaphragm and spacer ring as in FIGS. 5 (a) and (b) fabricated by micromachining process joined on metal ferrule of type shown in FIG. 3 (a).

FIG. 6(c): is the schematic illustration of the assembled FP fiber optic sensor in 2^{nd} embodiment with metallic diaphragm of FIG. 4 fabricated by micromachining process joined on metal ferrule of type shown in FIG. 3 (b).

FIG. 6(d): is the schematic illustration of the assembled FP fiber optic sensor in 2^{nd} embodiment of with metallic diaphragm and spacer ring as in FIGS. 5 (a) and (b)-fabricated by micromachining process joined on metal ferrule of type shown in FIG. 3 (b).

FIG. 6(e): is the schematic illustration of the assembled FP fiber optic sensor in 2^{nd} embodiment with metallic diaphragm of FIG. 5(a) fabricated by micromachining process joined on metal ferrule of type shown in FIG. 3 (c) with micro machined recessed cavity.

FIG. 7(a): illustrates the flow chart showing sequence of operations for machining of miniature sized metallic diaphragm as in FIG. 1(a) for assembly in FP interferometer sensor assembly.

FIG. 7(b): illustrates the flow chart showing sequence of operations for machining of larger sized metallic diaphragm as in FIG. 2 for assembly in FP interferometer sensor assembly.

FIG. 7(c): illustrates the flow chart showing sequence of operations for assembly of FP fiberoptic sensor system of miniature version according to the invention.

FIG. 7(d): illustrates the flow chart showing sequence of operations for assembly of FP fiberoptic sensor system for larger version.

FIG. 8: is the graphical presentation of a screen shot of the optical spectrum analyzer showing the intensity modulations of the reflected spectrum from FP cavity having a number of wavelength peaks and valleys corresponding to two applied pressure values e.g. 1 bar and 7 bar.

FIG. 9 (a): is the graphical presentation of the linear plot of best fit line for inverse of peak wavelengths versus ‘Order of peak’ for 1 bar pressure value measured by the FP fiber optic sensor system so that the slope defines the cavity length which is directly related to the measurand (pressure).

FIG. 9 (b): is the graphical presentation of the linear plot of best fit line for inverse of peak wavelengths versus ‘Order of peak’ for 7 bar pressure value measured by the FP fiber optic sensor system so that the slope defines the cavity length which is directly related to the measurand (pressure).

FIG. 10: is the graphical plot of the measured FP cavity length based on the proposed best fit line algorithm on spectral data versus the applied pressure in incremental steps using the FP fiber optic sensor system of the present invention.

### DETAILED DESCRIPTION OF THE INVENTION WITH REFERENCE TO THE ACCOMPANYING DRAWINGS

The present invention is directed to developing Fabry-Perot fiberoptic interferometer pressure sensor comprising a metal diaphragm, a spacer ring, a metal ferrule or sleeve, a pressure port and the optical fiber end secured in ferrule/sleeve wherein the diaphragm and the spacer ring are made by using micro machining techniques. Presently, a metal or alloy based sensing head has been used for fabrication of sensor to make it more robust and universal.

The sensor embodiments according to the present invention comprise at least a metallic diaphragm, and a metallic ferrule/sleeve on the fiber end. Such a sensor head has been developed using micro-nano machining processes for the metal diaphragm and the spacer ring defining the FP cavity and assembled/joined at optical fiber end to make a FP fiberoptic sensor. The functional element such as the metal diaphragm with high reflectivity inside surface facing the fiber, has been made by different micromachining processes and assembled/joined onto metallic ferrule/metallic sleeve at optical fiber end by welding to make a FP fiberoptic sensor. Pressure port are connected onto the basic FP assembly through the threads on metal ferrule and welded to ferrule for leak tightness.

According to one configuration of the FP fiber optic sensor, the flanged diaphragm structure has a recessed cavity made by ultra precision micro-nano turning process with depth equal to desired Fabry-Perot cavity length. The surface of the cavity has specular reflection.

According to yet another configuration, the Fabry-Perot cavity of the sensor head is defined by the spacer ring made by Photo Chemical Machining (PCM) process using lithography on metal sheet. The diaphragm can also be made out of a polished/buffed/nano finished sheet metal involving PCM process.

When the sensor assembly is subjected to the external parameter, say pressure, the diaphragm deflects and changes the FP cavity length. The detection of the cavity length is carried out based on White Light Interferometry. A broad band optical source such as the Tungsten-Halogen lamp or a super luminescent LED is used for injecting light through a single mode or multimode optical fiber into the Fabry-Perot cavity. The reflected spectrum from FP cavity has intensity modulation with number of wavelength peaks and valleys therein. The wavelength values for which peaks and/or valleys occur in the reflected spectrum can be found by using a diffraction grating based optical spectrum analyzer/Spectrometer and this can further be used to calculate the FP cavity length. Alternately, an optical cross co-relator can be used to find the FP cavity length.

A Data processing Algorithm is applied for signal spectrum wherein any two peaks (or valleys) can be used to calculate the FP cavity length. The experiments have shown variance in the calculated cavity length with different sets of peaks in a given signal spectrum. Using the fact that the peak wavelengths in FPI reflected optical spectrum follow harmonic progression; and that their inverse values must be in arithmetic progression and follow linearity with ‘Order No. of peak’; the slope of best fit line to (peak wavelength)⁻¹ versus the ‘Order No. of peak’ is used to determine the cavity length, which is directly related to the measurand i.e. pressure, temperature, strain etc.

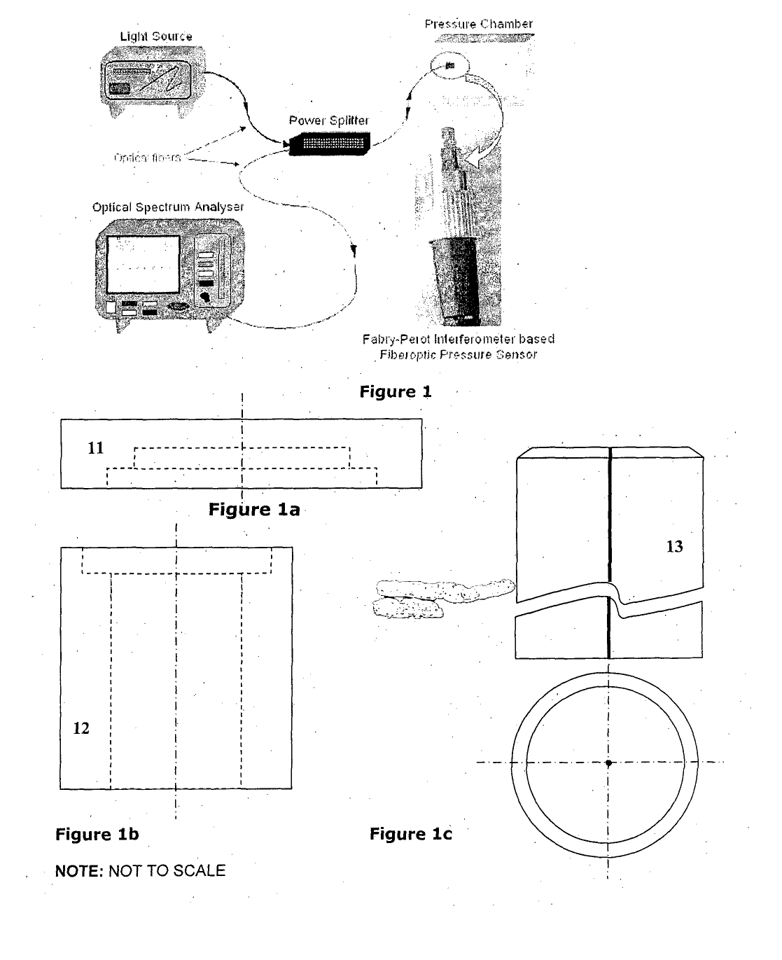

Reference is first invited to the accompanying FIG. 1 that schematically illustrate an embodiment for the metallic diaphragm based FP interferometer fiber optic sensor system according to the present invention for measurement of pressure as variable parameter, showing all the essential components of the system.

A broad band optical source is used as a light source for Fabry-Perot cavity. A power splitter couples the light from source to sensor and reflected spectrum from sensing head to optical spectrum analyzer/Spectrometer for further data analysis. The figure also shows in inset an embodiment of the Fabry-Perot Interferometer based fiberoptic pressure sensor. When the device is subjected to pressure, metal diaphragm deflects and causes the change of Fabry-Perot cavity length, which in turn changes the spectrum of optical signal. The signal spectrum is calibrated with the_measurand, pressure.

A miniature metal alloy sensing head is designed and developed as an external Fabry-Perot cavity interferometer at optical fiber end. The sensor head include at least a metallic diaphragm, and a metallic sleeve which is developed using micro-nano machining processes; and assembled/joined at optical fiber end to make a FP fiber optic sensor. Accompanying FIG. 1(a) shows the schematic illustration of a miniature metal alloy diaphragm (11) with micron sized step fabricated using micromachining for use in 1^{st} embodiment of Fabry-Perot fiber optic sensor; FIG. 1(b) is the schematic illustration of the sleeve (12) for sensor head of 1^{st} embodiment of FP fiber optic sensor and FIG. 1(c) shows the schematic illustration of the Standard ferruled end of an optical fiber (13) for coaxial connection with the sleeve for assembly with diaphragm to be used as sensor head for 1^{st} embodiment FP fiber optic sensor.

The fabrication of FP cavity on fiberoptics involved conventional tool based mechanical micro machining processes. The length of Fabry Perot cavity is controlled precisely within ±1 μm by the mechanical processes. The accuracy of diaphragm dimensions is controlled up to ±5 μm of defined value. The diaphragm surface facing fiber end has mirror finish which has very good reflectivity. Ultra miniature sensor configuration as illustrated is suitable for applications where size & weight are critical factor such as for biomedical application for in-situ determination of physiological parameters.

For fabrication of the metal diaphragm any of engineering metals and alloys such as Brass, Stainless Steel, Copper/Copper Alloy, and Nickel or Titanium Alloys can be selected as base metal. The stock/sheet thickness is selected with a thickness comprising the diaphragm finished thickness, plus allowance for two step depths, lapping allowance on outer face and Diamond Turning Machine (DTM) allowance on the FP cavity side face. To obtain desired dimension of the metal diaphragm for a particular application, nano regime deterministic machining process is carried out on sheet metal blank using:
a. Ultra precision machining and
b. Ultra Precision Single Crystal Diamond Tool;

A typical DTM applied in micro nano machining of miniature metal diaphragm according to the present invention is an ultraprecision machine having spindle run out ˜20 nm, positional accuracy ˜10 nm, with aerostatic spindle and hydrostatic table mounted on granite bed and vibration isolation system. The components are held on vacuum chuck to avoid distortion due to clamping force. Following steps are followed for micro nano machining of the metal diaphragm:

(i) At first step the outer diameter of the diaphragm is finished by any one of the methods viz. PCM, micro-EDM, micro-WEDM, micro-milling, micro turning, etc. The outer edges are deburred to remove the burrs and provide proper edge conditions like small radius or chamfer.

(ii) Next, one face of the blank is either manually or machine lapped to get flatness required for subsequent vacuum holding on DTM.

(iii) The lapped surface is then held on the DTM machine spindle using proper fixture and proper centering is done by standard industrial practices.

(iv) The front face of the blank is machined to maintain the total thickness.

(v) Then the machining of the first step which will stop and rest against the face of the metal/ceramic ferrule of the fiber optics cable, is machined. The step height from the face is maintained in this operation.

(vi) It is important to get the pip-free surface on the mirror like face of the FP cavity. To obtain this proper centre height of the tool has to be ensured. In spite of best efforts, the pip-free surface may not be possible to obtain. To overcome this, after machining the first step, the blank is off-set by few hundred microns, say 100 to 300 micron, and FP cavity is machined. This will allow the centre portion of the diaphragm w.r.t outside diameter, which will reflect the light, to be free from pip.

(vii) The critical parameters to be maintained are
The surface finish to give high reflection. In case of alloys, reflectivity is enhanced by flash coating of gold after diamond turning.
Pip-free surface corresponding to the fibre location.
The FP cavity length.

Typical tool specifications for DTM are
For non ferrous material diaphragm, Single crystal diamond tools with typical specifications of
   Top rake angle: 0°
   Rake plane: <110>
   Cutting edge waviness: <1 micron
   Cutting edge sharpness: <300 nm
   Tool nose radius: 0.2 mm (app)

For ferrous material diaphragm, Cubic Boron Nitride (CBN) tools with typical specifications of
Top rake angle: 0°
Cutting edge waviness. <1 micron
Cutting edge sharpness: <500 nm
Tool nose radius: 0.2 mm (app

Typical machining parameters used for turning/facing operation are
(i) For single crystal diamond tool
   Spindle speed: 2000-3000 rpm
   Feed/rev: 3-5 micron
   Depth of cut: 4-6 micron
(ii) For CBN tool
   Spindle speed: 1000-2000 rpm
   Feed/rev: 3-5 micron
   Depth of cut: 4-6 micron

Typical machining parameters for FP cavity machining are
(i) For single crystal diamond tool
   Spindle speed: 3000-6000 rpm
   Feed/rev: 1-2 micron
   Depth of cut: 1-3 micron
(ii) For CBN tool
   Spindle speed: 2000-3000 rpm
   Feed/rev: 2-4 micron
   Depth of cut: 2-4 micron

Typical range of dimensions of a micro machined and finished metal/metal alloy diaphragm for FP interferometer sensor with miniature as well as larger sensing head as used in the 1^{st} and 2^{nd} embodiment according to the present invention are as follows:

Thickness: 25 μm to few mm and preferably 25 μm to several hundreds of μm;

Diameter: 1 mm to 50 mm and preferably 1 mm to 25 mm;

Cavity length: <100 μm and preferably 10-50 μm

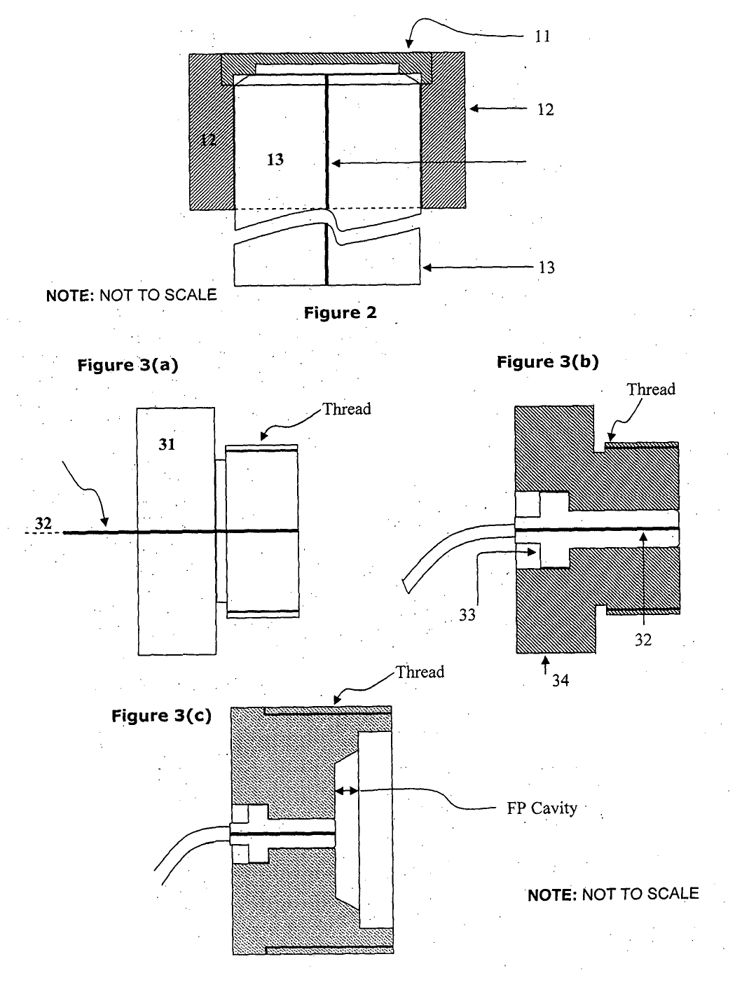

Accompanying FIG. 2 shows the schematic assembly of 1^{st} embodiment sensor wherein the optical fiber (13) is coaxially inserted inside the Sleeve (12) and the diaphragm (11) is fitted at the end of sleeve and joined by welding, preferably using LASER, Ultrasonic or Electron Beam welding.

Subsequently sensor head is customized to have a larger metal ferrule and correspondingly large micro machined diaphragm to achieve industrial grade, rugged pressure sensor of desired range.

Accompanying FIG. 3(a) shows the schematic illustration of the customized metal ferrule (22) for fabrication of sensor head in 2^{nd} embodiment for the FP fiber optic sensor according to the present invention.

Accompanying FIG. 3(b) shows the schematic illustration of the commercially available end connector comprising steel collar (33) connected to a metal ferrule (34) assembled with optical fiber (32) to be used for fabrication of sensor head in 2^{nd} embodiment for the FP fiber optic sensor according to the present invention.

Accompanying FIG. 3(c) shows the schematic illustration of another metal ferrule with a recessed micro machined concentric cavity which defines the FP cavity length and accommodates concentrically an optical fiber with prepared end face for fabrication of sensor head in 2^{nd} embodiment of the FP fiber optic sensor according to the present invention.

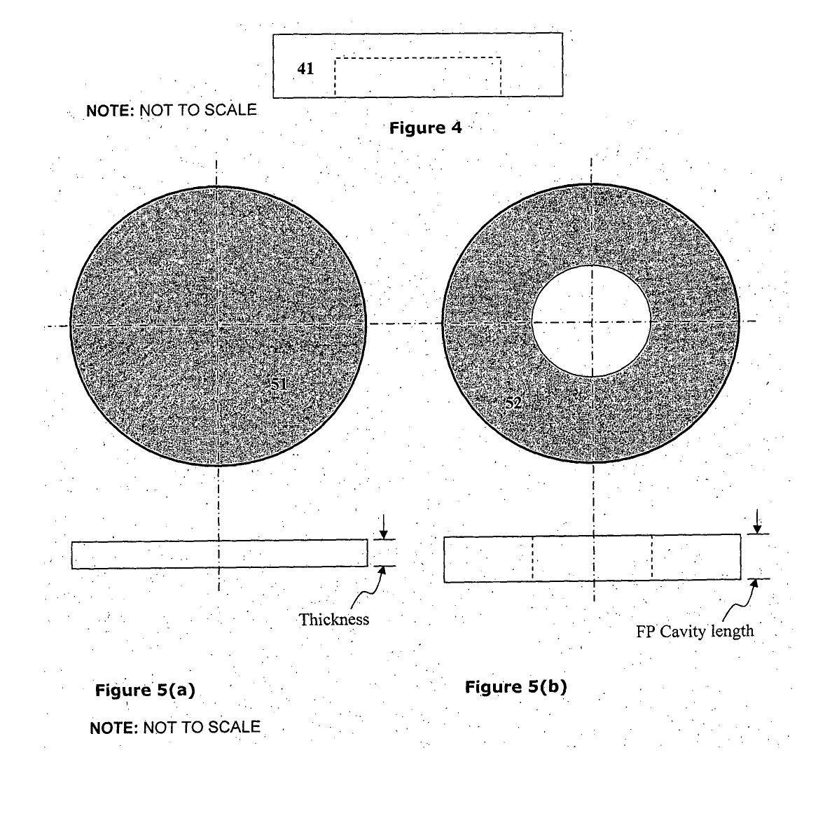

Reference is also invited to accompanying FIG. 4 that schematically illustrate the metal flanged diaphragm (41) with a recessed portion fabricated in 2^{nd} embodiment. The flanged diaphragm structure has a recessed cavity made by ultra precision micro-nano turning process with depth equal to desired FP cavity length. The inside surface of the metal diaphragm facing the fiber end has specular reflection. It is assembled on to the metal ferrule at optical fiber end by welding to make a FP fiberoptic sensor.

For machining larger size diaphragms, similar steps as of the miniature diaphragm are followed except that the spindle-speeds of app. 1000-2000 rpm for 10 mm diameter with diamond tool and 750-1500 rpm for CBN tools. However, larger sized diaphragms will have only one step forming FP cavity.

Accompanying FIG. 5(a) is the schematic illustration of the circular planar metal diaphragm (51) in 2^{nd} embodiment fabricated with photo chemical machining (PCM) process using lithography on metal sheet. The diaphragm is made out of a polished/buffed/nanomachined metal sheet by PCM process. The diaphragm inner surface is finished and made reflective by processes like ultra precision micro-nano turning, or buffing, or electro-chemical polishing. Accuracy and controllability is very good.

Accompanying FIG. 5(b) illustrates schematically the spacer ring (52) defining the FP cavity of the sensor head in an alternative FP cavity configuration, fabricated with photo chemical machining (PCM) process using lithography on Cu alloy based metal sheet. The spacer ring is made out of a sheet metal of known thickness by PCM process so that this thickness defines the FP cavity length.

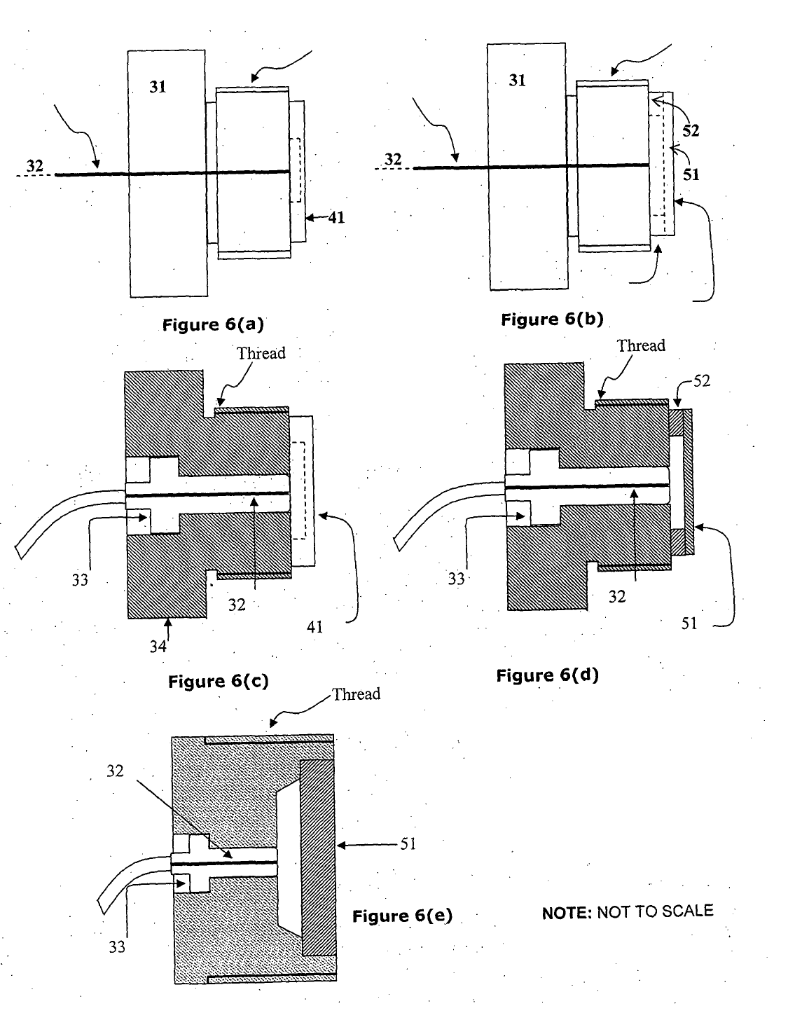

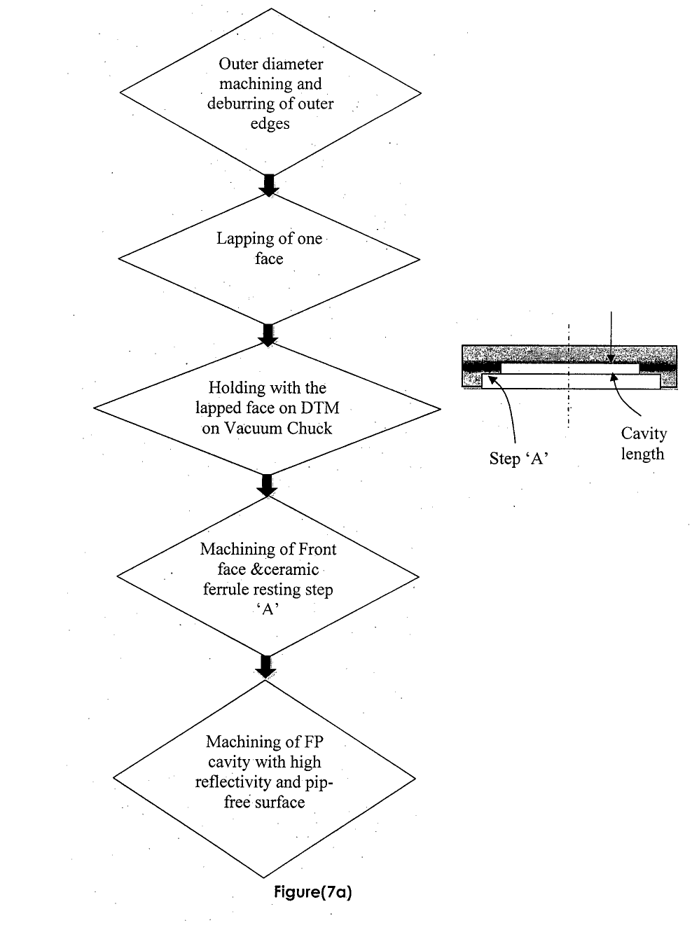

Reference is now invited to the accompanying FIG. 6(a) that schematically illustrate the assembled FP fiber optic sensor in 2^{nd} embodiment with metallic diaphragm based sensor head and FP cavity fabricated by micromachining process. It is apparent from accompanying FIG. 6(a) that the optical fiber (32) is secured inside the metallic ferrule (31) in such a way that its end face preferably matches with the fiber end face; and metal diaphragm (41) is welded on the end face of ferrule thus making a FP optical sensor.

According to an alternative embodiment of the metal diaphragm based FP fiber optic sensor as schematically illustrated in accompanying FIG. 6(b) shows the assembled FP fiber optic sensor in 2^{nd} embodiment with metallic diaphragm based sensor head and FP cavity fabricated by photo chemical machining (PCM) process. The optical fiber (32) is inserted inside the ferrule (31) and the diaphragm (51) is assembled at the end of ferrule with the spacer (52) placed in between. The metal alloy based diaphragm is welded with metallic ferrule by Laser, Ultrasonic or Electron beam welding process.

Accompanying FIG. 6(c) is the schematic illustration of the assembled FP fiber optic sensor in 2^{nd} embodiment with metallic diaphragm (41) of FIG. 4 fabricated by micromachining process joined on metal ferrule (34) of type shown in FIG. 3 (b).

Accompanying FIG. 6(d) is the schematic illustration of the assembled FP fiber optic sensor in 2^{nd} embodiment with metallic diaphragm (51) and spacer ring (52) as in FIGS. 5 (a) and (b)—fabricated by micromachining process joined on metal ferrule (34) of type shown in FIG. 3 (b).

Accompanying FIG. 6(e) is the schematic illustration of the assembled FP fiber optic sensor in 2^{nd} embodiment with metallic diaphragm (51) of FIG. 5(a) fabricated by micromachining process joined on metal ferrule (34) of type shown in FIG. 3 (c) with micro machined recessed cavity.

The 1^{st} embodiment basically involves a sensing head configuration on the fiber optic cable. Micro-nano machining processes is used to fabricate FP cavity assembled at fiber end; where depth of micromachined step defines the FP cavity length. It is miniaturized, light weight; so will be useful in application where weight and size of sensor is of prime importance e.g. medical field applications, intricate areas of a machine etc.

In 2^{nd} embodiment comprising of a customized Metallic ferrule connector that holds the fiber concentrically is designed and fabricated. Micro-nano machining processes are used to fabricate diaphragm and FP cavity; where depth of micromachined step defines the FP cavity length. In another process; PCM is used to fabricate the diaphragm and spacer; where spacer defines the cavity length. This embodiment favor rugged, robust and industrially applicable grade sensor developed on it.

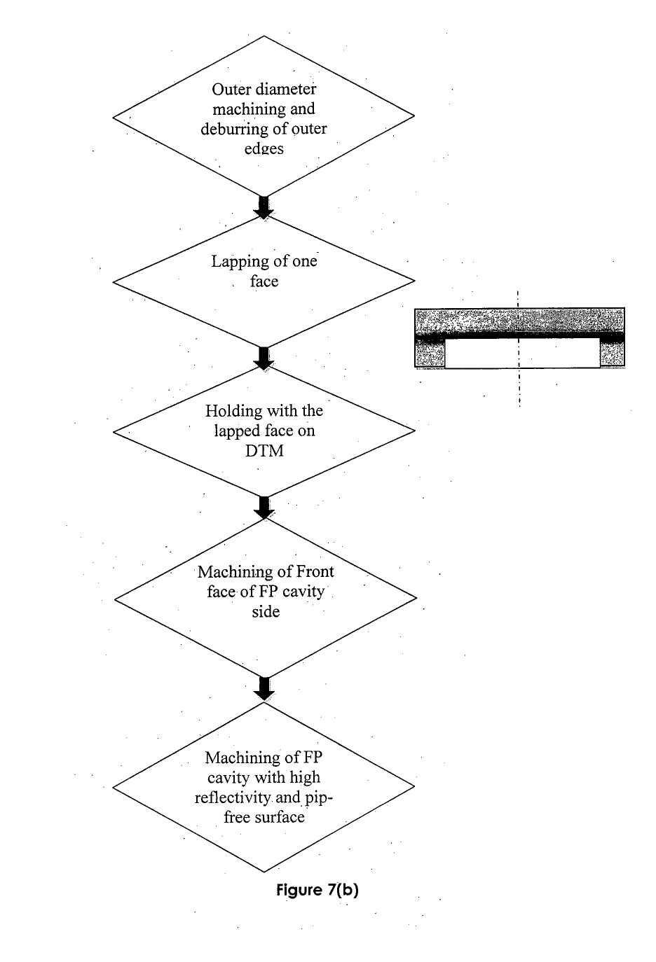

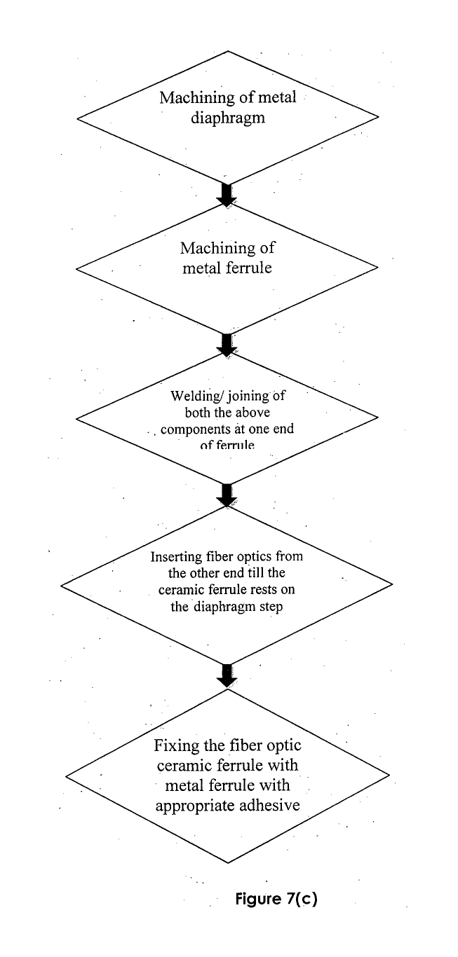

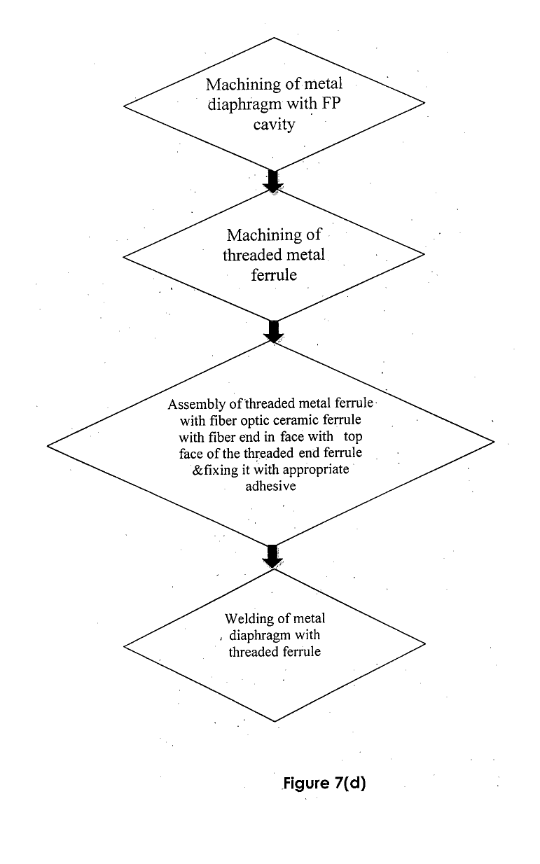

Accompanying FIGS. 7(a) and 7(b) illustrates the flow charts showing the basic steps involved in the micromachining of the miniature and the larger metallic diaphragm respectively involving Diamond turn machining.

Accompanying FIGS. 7(c) and 7(d) illustrates the flow chart showing the basic steps involved in assembly of the FP fiber optic sensor system of the miniature and the larger version respectively.

When metal alloys are used for diaphragm, the reflectivity value are generally lesser than that of pure metal. To enhance the reflectivity, preferably, gold coating of few tens to few hundred nm is carried out. This enhances the power of reflected signal desirable for optical signal analysis.

To carry out the method of measuring different parameters, the sensor assembly is subjected to the external parameter. Under the influence of external variable parameter the diaphragm deflects which changes the FP cavity length. The detection of the cavity length is based on White Light Interferometry. A broad band optical source (Tungsten-Halogen lamp) or a super luminescent LED is used for injecting light through a single mode or multimode optical fiber into the Fabry-Perot cavity. The reflected spectrum from FP cavity has intensity modulation with number of wavelength peaks and valleys therein. The wavelength values for which peaks and/or valleys occur in the reflected spectrum are found by using a diffraction grating based optical spectrum analyzer and this can further be used to, calculate the FP cavity length. Alternately, an optical cross co-relator can be used to find the FP cavity length.

Data processing algorithm is used to find any two peaks (or valleys) used to calculate the FP cavity length. There is a unique reflected pattern with respect to peak and valley position for a given cavity length and given external parameter. Any two peaks (or valleys) of a given spectrum can be used to calculate the FP cavity length. The experiments have shown large variance in the calculated cavity length with different sets of peaks of a given spectrum. Since the peak wavelengths in FPI reflected optical spectrum follow harmonic progression and their inverse values are in arithmetic progression and also follow linearity with ‘Order No. of peak’, the slope of best fit line is used to determine the cavity length, which is directly related to the measurand i.e. pressure, temperature, strain, vacuum, flow, depth etc.

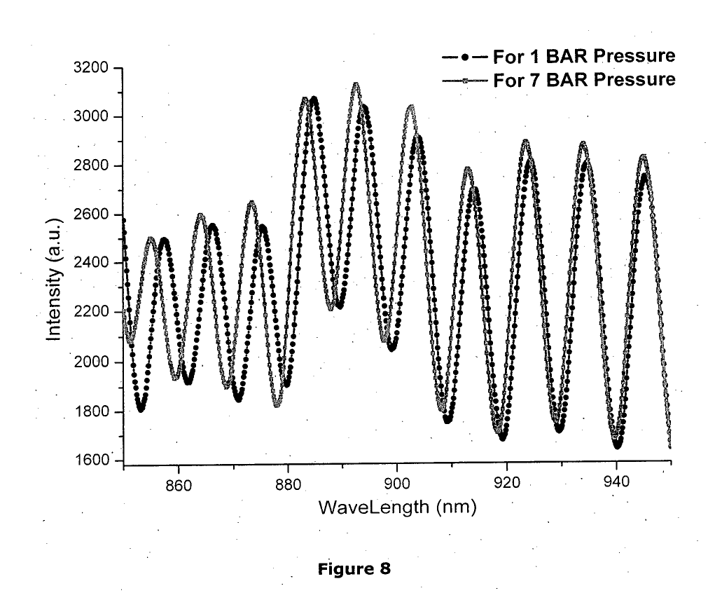

The FP interferometer based optical fiber as of the present invention is subjected to pressure so that metal diaphragm deflects and causes the change of Fabry Perot cavity length, which in turn changes the spectrum of optical signal. The change in spectrum is calibrated with pressure. There are many peaks & valleys for a given cavity length or given pressure and entire spectrum shifts with change in applied pressure. Accompanying FIG. 8 shows two spectra corresponding to 1 bar and 7 bar applied pressure; as detected by the spectrum analyzer based on the output signal generated by the micro machined metal diaphragm based FP interferometer fiber optic sensor according to the present invention.

The signal spectrum is seen by using an optical spectrum analyzer (OSA) based on diffraction grating and CCD linear image sensor. In the signal spectrum there are few numbers of peaks and valleys. Only two peaks (or valleys) are required for the calculation of FP cavity length. The positions of the peaks are known within close approximation in the signal spectrum. Calculations of the FP cavity length by taking different pairs of peaks may yield results with some variance. In the present case, (peak wavelength)⁻¹ is plotted versus the ‘order of peak’ and this shall ideally generate a ‘Straight Line’. A linear fit based on least square method has been performed. Any deviation of the data points from this ideal fit signifies the measurement error of peak positions (λpeak). By using this method, ‘fine positioning’ of the approximately known peak wavelengths are effectively done. However, the calculation of corrected peak position is not of much interest as the FP cavity length is directly calculated from the slope of the best fit line cavity length=|1/(2*slope)|). The inventiveness lies in the method of computing the cavity length from the signal data and determining therefrom precisely the parameter value of any measurand by suitable calibration of cavity length vs the measurand, covering a broad range with minimized error avoiding any variation in sensitivity due to variation in power or intensity of optical signal.

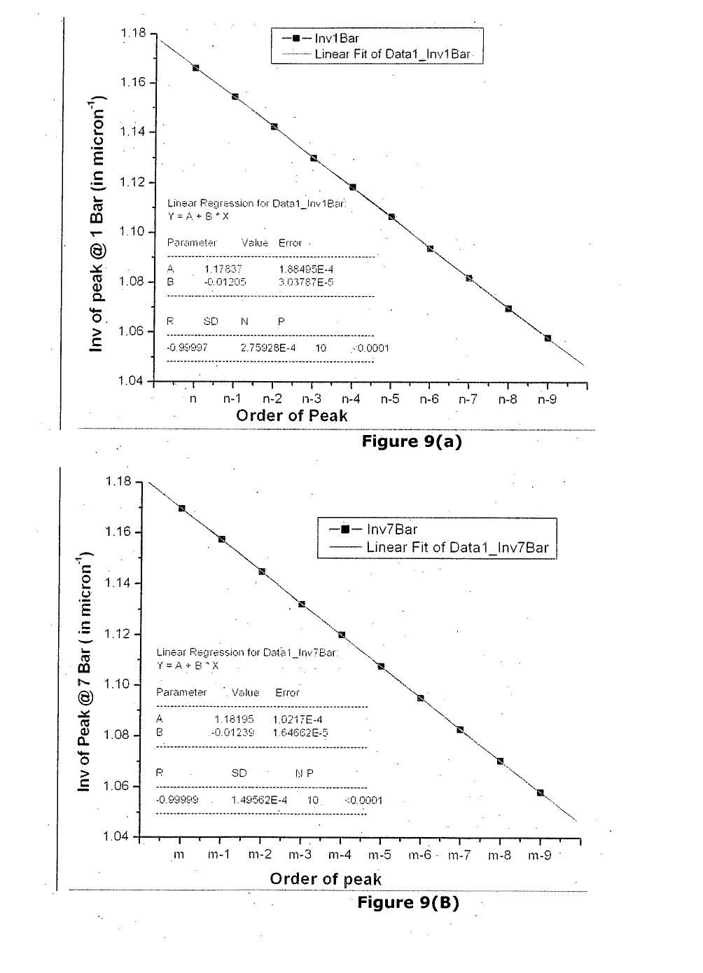

Accompanying FIG. 9 (a) is the graphical presentation of the linear plot of best fit line for inverse of peak wavelengths versus ‘Order of peak’ for 1 bar pressure value measured by the FP fiber optic sensor system so that the slope defines the cavity length which is directly related to the measurand (pressure).

Accompanying FIG. 9 (b) is the graphical presentation of the linear plot of best fit line for inverse of peak wavelengths versus ‘Order of peak’ for 7 bar pressure value measured by the FP fiber optic sensor system so that the slope defines the cavity length which is directly related to the measurand (pressure).

There would be a reflected spectrum corresponding to a given cavity length. Cavity length and corresponding spectrum will change when subjected to the pressure change. All the peaks (or valleys) would be in harmonics progression, so their reverse would be in arithmetic progression and form a straight line with order of peak. The slope of best fit line gives the cavity length and then cavity length=|1/(2*slope)|;

The data corresponding to the experimental graphs as shown in the accompanying FIG. 8 is presented in the following Example to illustrate the method of finding the calibration plot for the measurand.

### Example

| | λ_{Peak} | 1/λ_{Peak} | | λ_{Peak} | 1/λ_{Peak} |
|---|---|---|---|---|---|
| | @ 7 bar | @ 7 bar | | @ 1 bar | @ 1 bar |
| Peak_Order | (in nm) | (in μm⁻¹) | Peak_Order | (in nm) | (in μm⁻¹) |
| m | 855.06 | 1.169509 | n | 857.604 | 1.166039 |
| m − 1 | 864.04 | 1.157354 | n − 1 | 866.285 | 1.154355 |
| m − 2 | 873.468 | 1.144862 | n − 2 | 875.414 | 1.142317 |
| m − 3 | 883.346 | 1.132059 | n − 3 | 884.992 | 1.129954 |
| m − 4 | 892.846 | 1.120014 | n − 4 | 894.122 | 1.118416 |
| m − 5 | 902.846 | 1.107609 | n − 5 | 903.7 | 1.106562 |
| m − 6 | 913.129 | 1.095136 | n − 6 | 914.326 | 1.093702 |
| m − 7 | 923.629 | 1.082686 | n − 7 | 924.306 | 1.081893 |
| m − 8 | 934.129 | 1.070516 | n − 8 | 934.806 | 1.069741 |
| m − 9 | 945.129 | 1.058057 | n − 9 | 945.306 | 1.057859 |

Literature shows that

λₘ=2∫/m [symbol] 1/λₘ=m/2∫(slope B=½∫)

Where l is cavity length & m is the order of peak. It shows that slope for best fit line is ½l; where l is the cavity length. The linear plots above are showing the slope as −ve; while it is positive in above equation. If look carefully in the graph, we will see that x axis is reversed in the graphs, so slope with +ve x axis is +ve.

Cavity length at 1 bar (½B)=41.493 μm; B=0.01205 μm⁻¹

Cavity Length at 7 bar (½B)=40.355 μm; B=0.01239 μm⁻¹

During calibration a linear relationship between cavity length l & Pressure P is established. During measurement, spectrum & peaks are read, and then slope of best fit line, and then length from slope and finally pressure is calculated from the calibrated relationship between cavity length l & P.

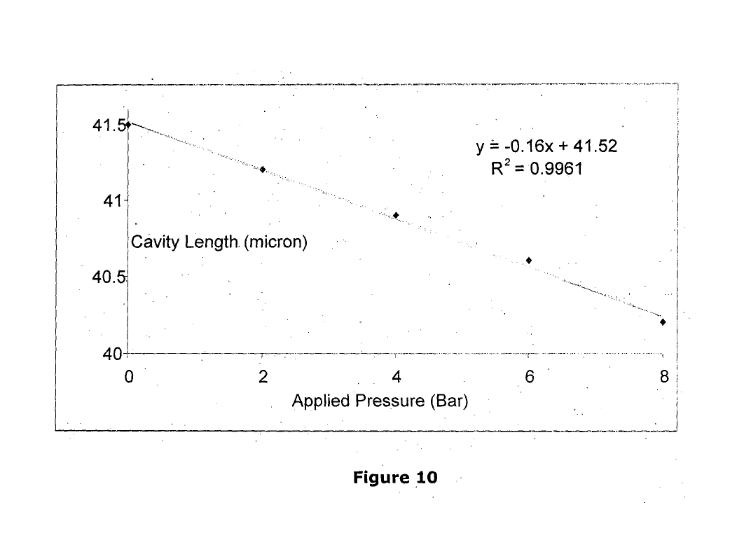

Accompanying FIG. 10 shows the plot of measured cavity length based on proposed best fit line algorithm on the spectral data versus the applied pressure which shows the proof of phenomena.

It is thus possible by way of the present invention to develop a highly reflective micro machined metal diaphragm based Fabry-Perot interferometric fiberoptic sensor system adapted to precise and accurate measurement of a range of different parameters e.g. pressure, temperature, strain and the like at extreme harsh operating condition as also in radiation or corrosive environment in a simple, safe and reliable manner. Importantly, the system involves an optical spectrum analyzer for analysis of the reflected spectrum from the interferometer so that the resultant change in spectrum due to change in the FP cavity length for a corresponding change in the external parameter being monitored, is directly calibrated with the measurand. The system and method of the invention advantageously favor developing miniature sensor for application where size and weight are critical factor. The FP interferometer fiber optic sensor according to the present invention thus having prospects of wide application for measuring process parameters in Nuclear, chemical, oil, gas, electrical and other industries having harsh/electronically harsh environment and also suitable for biomedical application with accuracy and controllability in a reliable and deterministic process.

1-32. (canceled)

33. A Fabry-Perot interferometer based fiber optic sensor system comprising:
a Fabry-Perot (FP) fiber optic sensor assembly involving a FP cavity defined by at least a metallic flexible diaphragm or sensing head comprising a flexible reflective metal diaphragm obtained involving Diamond Turn Machining (DTM) to provide a micro machined and nano-finished flexible reflective diaphragm surface having a surface finish of less than 10 nm and having a thickness in the range of 0.025 mm to few mm, preferably 0.025 mm to few hundred micrometers, and a diaphragm diameter in the range of 1 mm to 50 mm, preferably 1 mm to 25 mm, and a cooperatively connected or assembled metallic feruule or sleeve at an optical fiber end;
the flexible metallic diaphragm comprising a specular reflectivity inside surface facing the fiber end such that the flexible metallic diaphragm and the fiber end act as mirrors of the Fabry-Perot interferometer and form the FP cavity;
the FP cavity length comprising an ultra precision micro machined recessed cavity of predetermined depth fabricated on either the flexible metallic diaphragm or the metallic ferrule or sleeve;
a measurand operatively connecting to the assembly; and
the flexible metallic diaphragm adapted such that when it is subjected to an external parameter, the flexible metallic diaphragm deflects and changes the predetermined depth of the recessed cavity and thereby changing the FP cavity length which in turn changes the spectrum of an optical signal, wherein the change in spectrum is calibrated to favor measuring the external parameter.

34. The Fabry-Perot interferometer based fiber optic sensor system according to claim 33, wherein the flexible metallic diaphragm having the surface finish less than 10 nm for high reflectivity to act as a sensing element and a flatness of 2 μm across the metal ferrule diameter and the predetermined FP cavity length as recessed cavity on the diaphragm are obtained involving ultra precision turning process using DTM.

35. The Fabry-Perot interferometer based fiber optic sensor system according to claim 33, wherein the flexible metallic diaphragm is selected depending on a specific application, and wherein the flexible metallic diaphragm comprises engineering metals and alloys selected from the group consisting of brass, stainless steel, copper, copper alloy, nickel and titanium alloys.

36. The Fabry-Perot interferometer based fiber optic sensor system according to claim 33, comprising a coated optical fiber, and preferably a gold coated optical fiber, for enhanced sensor performance.

37. The Fabry-Perot interferometer fiber optic sensor system according to claim 33, wherein means for detection of the FP cavity length based upon interferometry comprises a broad band light source to interrogate the Fabry-Perot interferometer and an optical spectrum analyzer.

38. A process for the manufacture of the micro machined and nano-finished flexible metallic diaphragm for the Fabry-Perot interferometer based fiber optic sensor system according to claim 33 comprising the steps of:
providing a metal blank with suitable thickness, lapping its backside surface such that the metal blank can be held at vacuum chuck and obtaining the desired outside diameter; and
subjecting the metal blank to ultra precision micro machining involving single crystal diamond tools to obtain a suitable diaphragm thickness and the nano-finished minor like flexible reflective diaphragm.

39. A process for the manufacture of the ultra precision micro machined recessed cavity for the Fabry-Perot interferometer based fiber optic sensor system according to claim 33 comprising micro-machining of the recessed cavity including deterministic machining process carried out on the flexible metallic diaphragm or ferrule involving: a) ultra precision machining; and b) an ultra precision single crystal diamond tool.

40. A process for the manufacture of the ultra precision micro machined recessed cavity for the Fabry-Perot interferometer based fiber optic sensor system according to claim 33 comprising providing the metallic ferrule or sleeve involving hybrid machining process including DTM process including an ultra precision turning process, such that it is adapted to maintain the fiber end and the flexible metallic diaphragm parallel to each other and forms the FP cavity between the flexible metallic diaphragm and the fiber end.

41. A method for measuring an external parameter using the flexible metallic diaphragm based Fabry-Perot interferometer fiber optic sensor system according to claim 33 comprising the steps of:
injecting light through the optical fiber into the FP cavity from a broad band optical source;
generating intensity modulation of the reflected spectrum from the FP cavity with a number of wavelength peaks and valleys therein;
computing inverse values of peak wavelengths in the Fabry-Perot interferometer reflected optical spectrum which are in arithmetic progression and follow linearity with order number of peak;
using the slope of the best fit line for (peak wavelength)⁻¹ versus the parameter value to determine the FP cavity length where the FP cavity length=|1/(2*slope)|; and
obtaining a measurand value which is directly proportional to the FP cavity length.

42. The method for measuring an external parameter using the flexible metallic diaphragm based Fabry-Perot interferometer fiber optic sensor system according to claim 41 wherein the broad band optical source comprises a Tungsten-Halogen Lamp or a super luminescent LED and wherein the measurand value comprises pressure, temperature, strain and vacuum.
